(19) United States
(12) Patent Application Publication
(10) Pub. No.: US 2009/0079323 A1
(43) Pub. Date: Mar. 26, 2009

(54) PLASMA DISPLAY PANEL AND PLASMA DISPLAY PANEL UNIT

(76) Inventors: Masashi Gotou, Osaka (JP); Kyohei Yoshino, Osaka (JP); Masaki Nishimura, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 11/914,534

(22) PCT Filed: Jun. 1, 2006
(86) PCT No.: PCT/JP2006/310987

§ 371 Date: Nov. 15, 2007

(30) Foreign Application Priority Data
Jun. 2, 2005 (JP) 2005-162875

(51) Int. Cl. H01J 63/04

(52) U.S. Cl. 313/485

(57) ABSTRACT

In a panel unit of a PDP apparatus, a discharge space is filled with a discharge gas containing a xenon gas as a principal component and a neon gas at a total pressure in a range of 1×10⁴ [Pa]-5×10⁴ [Pa], inclusive. Since the discharge gas is a xenon-neon binary gas mixture, when a partial pressure ratio of the neon gas to the total pressure ratio of the discharge gas is set at 8[%] or below, the rest of the discharge gas is the xenon gas, the principal component. In summary, the PDP apparatus of the present invention can attain high luminous efficiency with use of the high xenon gas content, and suppress erosion of a protective layer as a result of sputtering caused by a discharge during driving with use of the neon gas whose partial pressure ratio is 8[%] or below.

### TECHNICAL FIELD

The present invention relates to a plasma display panel and a plasma display panel apparatus, and in particular to a gas component filled in a discharge space.

### BACKGROUND ART

In recent years, plasma display panel apparatuses (hereinafter, referred to as “PDP apparatus”) have come to be widely used as flat display apparatuses. There are two types of the PDP apparatuses, a direct-current type (DC-type) and an alternating-current type (AC-type). Among AC-type PDP apparatuses which possess a high technological potential for realizing a large display apparatus, an AC-type surface discharge PDP apparatus is especially favored for its advantageous lifetime characteristics.

The PDP apparatus is constituted from a panel unit that displays an image and a drive unit that drives the panel unit based on an inputted image signal. The panel unit includes a front panel and a back panel that are placed opposing each other via a gap, and is sealed at edge portions.

The front panel, one panel of the panel unit, includes a glass substrate. On a main surface of the glass substrate, a plurality of display electrode pairs (each of which is composed of a scan electrode and a sustain electrode) are formed in parallel to each other in a stripe pattern, and are covered by a dielectric layer and a protective layer in the stated order. The back panel, another panel of the panel unit, includes a glass substrate. On a main surface of the glass substrate, data electrodes are formed in a stripe pattern, and are covered by a dielectric layer. Protruding barrier ribs are provided in a stripe pattern or grid pattern on the dielectric layer. In addition, the dielectric layer and the adjoining barrier ribs form a concave portion, and a phosphor layer is formed on an inner wall surface of the concave portion.

The front and back panels are arranged such that the display electrode pairs and the data electrodes intersect three-dimensionally. A space (discharge space) between the front and back panels is filled with a gas mixture such as xenon-neon (Xe—Ne) or xenon-neon-helium (Xe—Ne—He). In the panel unit, each area at which the display electrode pairs intersect the data electrodes three-dimensionally corresponds to a discharge cell. The drive unit of the PDP apparatus is connected to the display electrode pairs and the data electrodes in the panel unit for applying a voltage pulse to the individual electrodes.

The drive unit drives the panel unit using an in-field time division gray scale display method. This method divides one field of an inputted image into a plurality of subfields each of which is constituted from a reset period, a write period, and a sustain period.

However, there has been a demand for an improvement on luminous efficiency (discharge efficiency) of the PDP apparatus, and various approaches have been made in response to the demand. One of such approaches is a study on increasing the ratio of xenon in a discharge gas. For example, suggestions have been made that the discharge gas is composed of 100[%] of an Xe gas (Patent Document 1, listed below), and that the partial pressure ratio of the Xe gas to the total pressure ratio of the discharge gas falls in a range of 10[%] to 100[%] and that a fill pressure of the discharge gas is set to be as ultrahigh as 6×10⁴ [Pa] (Patent Document 2, listed below).
Patent Document 1: Japanese Laid-Open Patent Application Publication No. 2002-83543
Patent Document 2: Japanese Laid-Open Patent Application Publication No. 2002-93327

### DISCLOSURE OF THE INVENTION

### Problems the Invention is Attempting to Solve

However, when the ratio of the Xe gas in the discharge gas is raised higher than that of a conventional PDP apparatus, the protective layer tends to get prominently eroded as a result of sputtering caused by the sustain discharge generated on driving. For that reason, it is conventionally thought that the high content of the Xe gas in the discharge gas is inadequate for maintaining a high and stable display quality for a long period of driving. Aside from this, it should be noted that too high a firing voltage on driving may occur when the discharge gas does not include any Ne gas as in Patent Document 1 or when the total pressure of the discharge gas is ultrahigh as in Patent Document 2. Thus, both techniques disclosed in Patent Documents 1 and 2 are inappropriate for realizing a practical PDP apparatus.

The present invention is conceived in view of the above problem, and aims to provide a plasma display panel and a plasma display panel apparatus that can maintain high luminous efficiency and a stable display quality for a long time of driving.

### Means for Solving the Problems

The present inventors have investigated a relationship between the discharge gas component and the erosion of the protective layer caused by sputtering as a result of the discharge during driving, and found the following mechanism. That is, when the partial pressure ratio of an Xe gas to the total pressure of the discharge gas is in a range of 5[%] to 30[%], though the luminous efficiency improves, the protective layer is increasingly eroded with an increase in the partial pressure ratio of the Xe gas. Furthermore, the present inventors have confirmed that the discharge gas containing more than 30[ ] of the Xe gas leads to an increase in an amount of the erosion of the protective layer to a level that is not negligible in manufacturing a practical PDP apparatus.

The present inventors have further found that the discharge gas made of a 100[%] Xe gas with no Ne gas, as in Patent Document 1, suppresses the protective layer from being eroded as a result of sputtering caused by a discharge during driving. Furthermore, the present inventors have examined sputtering rates when the Ne gas content (partial pressure ratio) in the discharge gas is in a range of 1[%] to 10[%], and found that the smaller the content is, the smaller the erosion of the protective layer as a result of sputtering is.

The present inventors have found from these investigations that the Ne gas content in the discharge gas is an important factor that determines the amount of the erosion of the protective layer as a result of sputtering during driving.

Consequently, the present invention adopts the following features.

A plasma display panel pertaining to the present invention has a pair of substrates (a first substrate and a second substrate) that opposes each other with a space therebetween. A plurality of electrode pairs, a dielectric layer, and a protective layer are stacked in the stated order on a main surface of one of the substrates (the first substrate), and the protective layer faces the space. A phosphor layer that faces the protective layer is disposed over a main surface of another substrate (the second substrate). The space is filled with a discharge gas. The discharge gas contains a principal gas component composed of a component that emits light to excite a phosphor in the phosphor layer during a plasma discharge, and a neon gas. The principal gas component is contained at a principal ratio of the discharge gas, and the neon gas is contained at a partial pressure ratio of 8[%] or less to a total pressure of the discharge gas. The wording “(the neon gas is contained at a) partial pressure ratio” used herein refers to a value that is obtained by dividing the partial pressure of the Ne gas by the total pressure of the discharge gas.

Note that the “principal ratio” of the principal gas component in the above description means the highest partial pressure ratio to the total pressure of the discharge gas. For example, for a binary gas mixture, any ratio larger than 50[%] is the principal ratio, and for a ternary gas mixture, any ratio larger than 33.3[%] is the principal ratio.

In another aspect, the present invention provides a PDP apparatus having the above-mentioned PDP structures and a drive unit that applies, in accordance with an inputted image signal, a voltage pulse to each electrode constituting the electrode pairs of the PDP.

### EFFECTS OF THE INVENTION

Since the principal gas component of the discharge gas accounts for the principal ratio as described above, the PDP and the PDP apparatus pertaining to the present invention possess high luminous efficiency (discharge efficiency). In addition, since the Ne gas is contained in the discharge gas of the PDP and the PDP apparatus, a lower firing voltage can be maintained compared with the PDP of Patent Document 1 that contains no Ne gas.

Furthermore, since the partial pressure ratio of the Ne gas is specified to 8[%] or below, the protective layer is suppressed from being eroded as a result of sputtering caused by Ne ions generated in a discharge during driving. Thus, the PDP and the PDP apparatus are able to maintain a high display quality for a long time of driving.

Accordingly, the PDP and the PDP apparatus pertaining to the present invention are advantageous for maintaining a stable display quality while keeping high luminous efficiency for a long time of driving.

In the PDP and the PDP apparatus pertaining to the present invention, the dielectric layer that has a thickness of less than 20 [μm] is desirable. The protective layer with the above thickness contributes to keep a low firing voltage on driving of the panel, therefore is favorable for suppressing damages to the protective layer as a result of sputtering caused by a discharge during driving.

In the PDP and the PDP apparatus pertaining to the present invention, the neon gas is desired to be contained at a partial pressure ratio of 5[%] or less to the total pressure of the discharge gas. The low content of the Ne gas is effective in suppressing the erosion of the dielectric layer caused by sputtering during driving without the need to specify the thickness of the dielectric layer as described above.

In the PDP and the PDP apparatus pertaining to the present invention, the neon gas that is contained at a partial pressure ratio of at least 0.2[%] to the total pressure of the discharge gas is practical. Furthermore, the neon gas is preferably contained at a partial pressure ratio of at least 3[%] to the total pressure so that the aging time in manufacturing can be as short as that required for manufacturing a PDP apparatus with a conventional panel structure.

In the PDP and the PDP apparatus pertaining to the present invention, it is desirable to contain an argon gas in the discharge gas. This is to take advantage of Penning effect of Ar atoms, which further suppresses the firing voltage and improves luminous efficiency.

In the PDP and the PDP apparatus pertaining to the present invention, it is desirable to set the total pressure of the discharge gas to be from 1×10⁴ [Pa] to 5×10⁴ [Pa], inclusive. This is because the luminous efficiency decreases compared with that of a conventional PDP apparatus when the total pressure ratio is set lower than 1×10⁴ [Pa]. This is also because the firing voltage becomes too high when the total pressure ratio is set higher than 5×10⁴ [Pa], as in Patent Document 2. These phenomena are prominent especially when the partial pressure ratio of the Xe gas is high. When both partial pressure ratio of the Xe gas and total pressure of the discharge gas are high, breakdown of the dielectric layer presents a particular concern. Preferably, the total pressure of the discharge gas is from 1.7×10⁴ [Pa] to 5×10⁴ [Pa], inclusive.

In addition, in the PDP and the PDP apparatus pertaining to the present invention, it is desirable that each electrode that constitutes the electrode pairs is made of a metal material. This is because it is achievable to keep the surface area of the respective electrodes that constitute the display electrode pairs to a minimum area, for the PDP and the PDP apparatus pertaining to the present invention achieve high luminous efficiency as described above. Note that each electrode constituting the display electrode pairs of a conventional PDP usually has a layered structure of a transparent electrode made of ITO (indium tin oxide) and a bus electrode made of a metal material. However, an electrode made solely of the metal material is sufficient for the PDP and the PDP apparatus of the present invention, and a transparent electrode is unnecessary. Consequently, manpower that is required for manufacturing the transparent electrode can be reduced. Thus, the PDP and the PDP apparatus pertaining to the present invention are advantageous in lowering manufacturing cost when the above electrode structure is employed.

In the PDP and the PDP apparatus pertaining to the present invention, magnesium oxide is applicable for the protective layer, and one of a xenon gas and a krypton gas is applicable for the principal gas component.

Furthermore, in the PDP and the PDP apparatus pertaining to the present invention, each of the electrode pairs on the main surface of the first substrate includes two electrodes that are spaced from each other at a distance desirably from 40 [μm] to 70 [μm], inclusive, which is favorable for reducing reactive power and suppressing occurrence of spots. More specifically, when the distance is shorter than 40 [μm], the reactive power becomes impracticably high. When the distance is larger than 70 [μm], with a high partial pressure ratio of the Xe gas, an undesired strong discharge (erroneous discharge) occurs during a reset period, and subsequently in a sustain period, some of discharge cells unintentionally emit light (occurrence of spots). However, the discharge gap at the distance from 40 [μm] to 70 [μm], inclusive, as employed in the PDP and the PDP apparatus pertaining to the present invention, is favorable for decreasing the reactive power and suppressing the occurrence of spots.

When barrier ribs are each disposed on a surface of the dielectric layer on the second substrate between the electrodes that are adjacent to each other, a height from a top of each barrier rib to the surface of the dielectric layer on the second substrate is desired to be larger than the distance between the two electrodes with an object of reducing the occurrence of spots. More specifically, the height from the top of each barrier rib to the surface of the dielectric layer on the second substrate is desired to be from 75 [μm] to 120 [μm], inclusive.

In addition, when a grid-shaped barrier rib structure with the sub-barrier ribs intersecting the main barrier ribs is adopted, the height from the top of each barrier rib to the surface of the dielectric layer on the second substrate is larger than a height from a top of each sub-barrier rib to the surface of the dielectric layer on the second substrate. Moreover, a difference in the height of each barrier rib and the height of each sub-barrier rib is desired to be from 8 [μm] to 15 [μm], inclusive. Thus, the occurrence of spots is suppressed.

Note that the difference in the height of the barrier rib and the sub-barrier rib below 8 [μm] is impractical considering variance in size and exhaust efficiency in the discharge space in manufacturing the PDP. The difference in the height is preferred to be 15 [μm] or below from the point of preventing an erroneous discharge between adjoining discharge cells in a column direction (discharge cells that are adjacent to each other across a sub-barrier rib).

### BRIEF DESCRIPTION OF THE DRAWINGS

FIG. 1 is a perspective view of a main part of a panel unit 10 of a PDP apparatus 1 pertaining to a first embodiment of the present invention;

FIG. 2 is a block diagram schematically showing a structure of the PDP apparatus 1;

FIG. 3 is a waveform chart showing waveforms of a voltage applied to respective electrodes when the PDP apparatus 1 is driven;

FIG. 4 is a characteristic chart of the panel unit 10 showing a relationship between a partial pressure ratio of a neon gas in a discharge gas and a sputtering rate;

FIG. 5 is a characteristic chart of the panel unit 10 showing a relationship between the partial pressure ratio of the neon gas in the discharge gas and a firing voltage;

FIG. 6 is a characteristic chart of a PDP apparatus pertaining to a second embodiment of the present invention showing a relationship between a partial pressure ratio of a neon gas in a discharge gas and a sputtering rate;

FIG. 7 is a characteristic chart of a PDP apparatus pertaining to a third embodiment of the present invention showing a relationship between a partial pressure ratio of a neon gas in a discharge gas and a sputtering rate;

FIG. 8 is a characteristic chart showing a relationship between a thickness of a dielectric layer and the sputtering rate;

FIG. 9 is a characteristic chart showing a relationship between the partial pressure ratio of the neon gas in the discharge gas and an aging time;

FIG. 10 is a characteristic chart showing a relationship between a discharge gap and a frequency of spot occurrence; and

FIG. 11 is a characteristic chart showing a relationship between a height of barrier ribs and the frequency of spot occurrence.

### REFERENCE NUMERALS

1 PDP apparatus
10 panel unit
11 front panel
12 back panel
13 discharge space
20 display drive unit
21 data driver
22 scan driver
23 sustain driver
24 timing generator
25 A/D converter
26 scan number converter
27 subfield converter
111, 121 substrate
112 display electrode pairs
113, 122 dielectric layer
114 protective layer
123 barrier ribs
124 phosphor layer
Scn scan electrode
Sus sustain electrode
Dat data electrodes

### BEST MODE FOR CARRYING OUT THE INVENTION

The following describes the best mode for carrying out the present invention using embodiments. Note that the embodiments in the following description are merely examples, and the present invention is not limited to these.

### First Embodiment

### 1. Structure of Panel Unit 10

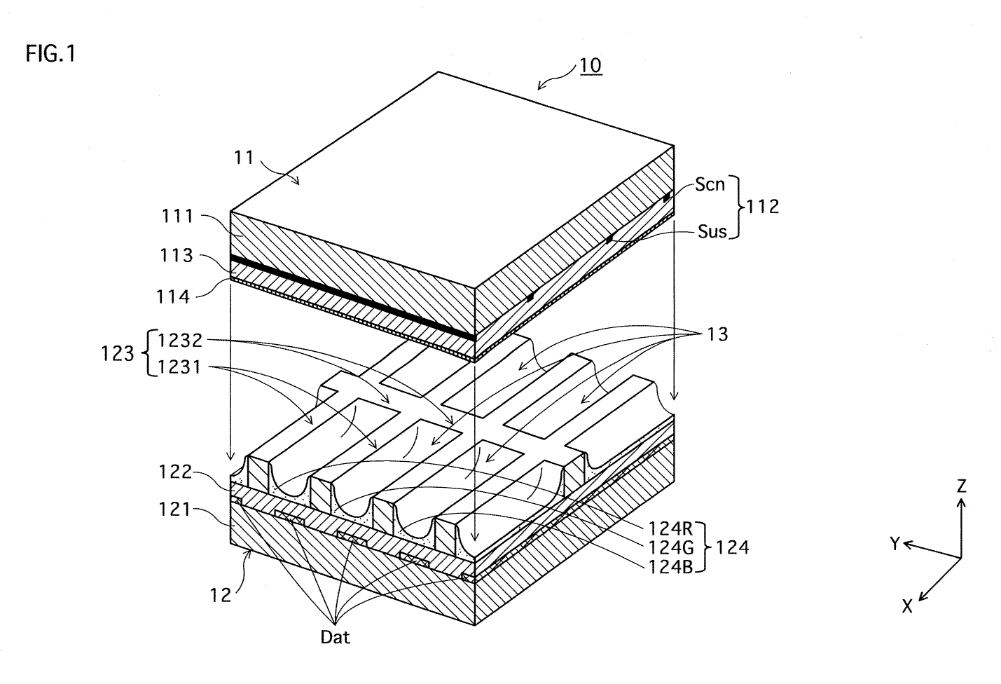

Among constituent elements of a PDP apparatus 1 in a first embodiment of the present invention, a structure of a panel unit 10 is described as follows with reference to FIG. 1. FIG. 1 is a perspective view (partially sectional view) of a main part of the panel unit 10.

As shown in FIG. 1, the panel unit 10 includes two panels 11 and 12 opposing each other with a discharge space 13 therebetween.

### 1-1. Structure of Front Panel 11

As shown in FIG. 1, the front panel 11, a constituent element of the panel unit 10, has a plurality of display electrode pairs 112, each made up of a scan electrode Scn and a sustain electrode Sus, is formed in parallel to each other on a main surface (facing downward in FIG. 1) of a front substrate 111 that faces toward the back panel 12. A dielectric layer 113 and a protective layer 114 are laminated to cover the display electrode pairs 112 in the stated order.

The front substrate 111 is made of, for example, high-strain-point glass or soda-lime glass. Each scan electrode Scn and each sustain electrode Sus is made of a metal material (e.g. Ag), and does not include any of ITO (tin-doped indium oxide), SnO₂ (tin oxide), and ZnO (zinc oxide) as a constituent material. Note, however, that it is possible for the scan electrode Scn and the sustain electrode Sus to include such constituent materials as ITO, SnO₂, and ZnO.

Additionally, the dielectric layer 113 is made of a non-lead and low-melting glass material, and the thickness is designed to be approximately 25 [μm]. The protective layer 114 is made of MgO (magnesium oxide).

Note that a black stripe may be provided between the adjacent display electrode pairs 112 on the surface of the front substrate 111 in order to prevent light of discharge cells from leaking to the adjoining discharge cells.

### 1-2. Structure of Back Panel 12

The back panel 12 has a plurality of data electrodes Dat on a main surface (facing upward in FIG. 1) of a back substrate 121 opposing the front panel 11. The data electrodes are disposed intersecting the display electrode pairs three-dimensionally. The dielectric layer 122 is formed covering the data electrodes Dat. On the dielectric layer 122, a plurality of main barrier ribs 1231 and sub-barrier ribs 1232 are formed. Each main barrier rib 1232 is located between two adjacent data electrodes. The sub-barrier ribs 1232 are arranged so as to cross the main barrier ribs 1231. In the panel unit 10 of the present embodiment, barrier ribs 123 are composed of the main barrier ribs 1231 and the sub-barrier ribs 1232. Although not illustrated in FIG. 1, a top of the sub-barrier ribs 1232 is slightly lower than a top of the main barrier ribs 1231 in the Z direction.

A phosphor layer 124 is formed on inner walls of a plurality of concave portions that are surrounded by the dielectric layer 122 on the bottom, two main barrier ribs 1231 and two sub-barrier ribs 1232 on the side. The concave portions of each row in the X direction all have the same one of three colors of the phosphor layers. In the Y direction shown in FIG. 1, each three concave portions adjacent via the main barrier ribs 1231 has a different one of the three colors of the phosphor layer 124R, 124G, and 124B.

As with the front substrate 111, the back substrate 121 of the back panel 12 is made of high-strain-point glass or soda-lime glass. The data electrodes Dat are made of a metal material such as Ag similarly to the scan electrode Scn and the sustain electrode Sus. Note that the data electrodes Dat may be made of any other metal material such as gold (Ag), chromium (Cr), copper (Cu), nickel (Ni), and platinum (Pt), or may have a layered structure of combination of the metal materials.

The dielectric layer 122 is made of non-lead and low-melting glass, basically similar to the dielectric layer 113 of the front panel 11. However, aluminum oxide (Al₂O₃) or titan oxide (TiO₂) may also be contained. The barrier ribs 123 are made of, for example, a glass material.

Each color of the phosphor layers, 124R, 124G, and 124B is made of the following phosphors alone or in combination.

Red (R) phosphor; (Y, Gd) BO₃: Eu
YVO₃: EU

Green (G) phosphor; Zn₂SiO₄: Mn
(Y, Gd) BO₃: Tb
BaAl₁₂O₁₉: Mn

Blue (B) phosphor; BaMgAl₁₀O₁₇: Eu
CaMgSi₂O₆: Eu

### 1-3. Arrangement of Front Panel 11 and Back Panel 12

As shown in FIG. 1, the panel unit 10 is constructed such that the front panel 11 and the back panel 12 oppose each other with the barrier ribs 123 as a gap material disposed therebetween, and the display electrode pairs 112 and the data electrodes Dat extend in a direction orthogonal to each other. The front panel 11 and back panel 12 are sealed at edge portions, thereby forming a hermetically sealed container in which the discharge space 13 is partitioned by the barrier ribs 123.

A discharge gas made up of a xenon (Xe) gas and a neon (Ne) gas is enclosed in the discharge space 13, where a total pressure of the discharge gas is adjusted to 5×10⁴ [Pa]. In the panel unit 10 of the present embodiment, the partial pressure ratio of the Ne gas to the total pressure ratio of the discharge gas is set to 5[%]. That is to say, the partial pressure ratio of the Xe gas to the total pressure ratio in the discharge gas is 95[%] in the panel unit 10. The Xe gas, which is the principal gas component, in the discharge gas emits vacuum ultraviolet rays which excite respective phosphors constituting the phosphor layers 124 caused by a discharge during driving.

In the panel unit 10, each area at which the display electrode pairs 112 intersect the data electrodes three-dimensionally corresponds to a discharge cell (unillustrated), and the plurality of the discharge cells are arranged in a matrix.

### 2. Structure of PDP Apparatus 1

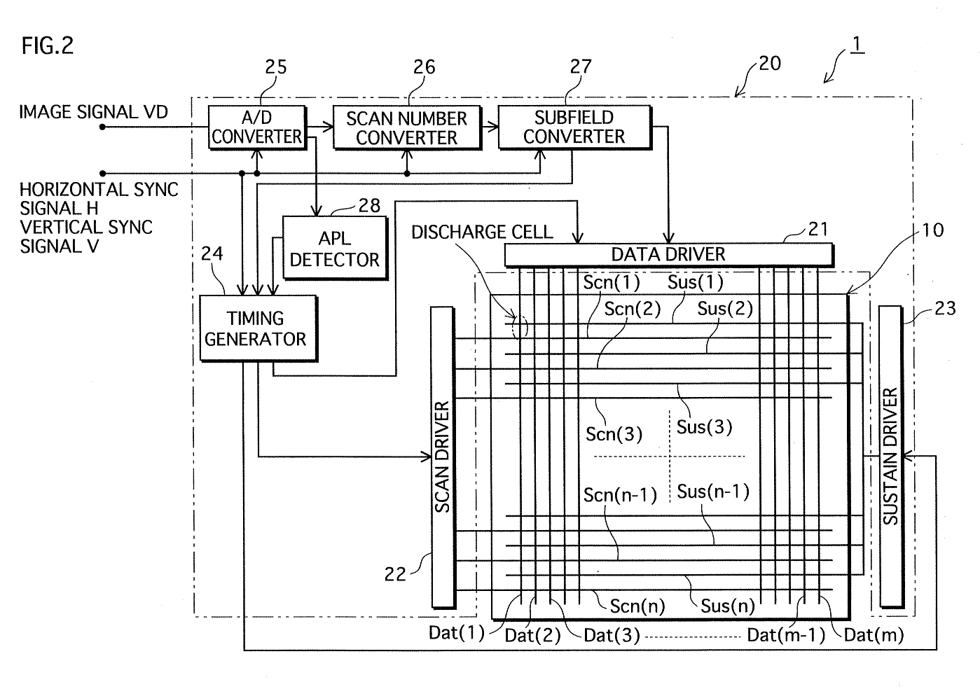

The PDP apparatus 1 including the above panel unit 10 is described with reference to FIG. 2. FIG. 2 is a block diagram schematically showing a structure of the PDP apparatus 1. Note that FIG. 2 shows only an arrangement of the electrodes Scn, Sus, and Dat.

As shown in FIG. 2, the PDP apparatus 1 pertaining to the present embodiment includes the panel unit 10 and a display drive unit 20 that applies a voltage having a required waveform to the individual electrodes Scn, Sus, and Dat at a required timing. In the panel unit 10, n scan electrodes Scn (1) to Scn (n) and n sustain electrodes Sus (1) to Sus (n) are arranged alternately.

In addition, m data electrodes Dat (1) to Dat (m) are arranged in a column direction in the panel unit 10. A discharge cell of the panel unit 10 is formed in an area corresponding to an area at which a pair of the scan electrode Scnk (k=1−n) and the adjacent sustain electrode Susk (k=1−n) intersects a data electrodes Datl (l=1−m). Thus, the entire panel unit 10 includes (m×n) discharge cells.

As shown in FIG. 2, the display drive unit 20 includes a data driver 21, a scan driver 22, and a sustain driver 23 which are connected to the electrodes Scn, Sus, and Dat, respectively. The display drive unit 20 further includes a timing generator 24, an A/D converter 25, a scan number converter 26, a subfield converter 27, and an APL (Average Picture Level) detector 28, in addition to the drivers 21, 22 and 23. Although not illustrated in FIG. 2, the display drive unit 20 also includes a power supply circuit. An image signal VD is inputted to the A/D converter 25, and a horizontal sync signal H and a vertical sync signal V are inputted to the timing generator 24, the A/D converter 25, the scan number converter 26, and the subfield converter 27.

The A/D converter 25 of the display drive unit 20 converts the inputted image signal VD into a digital signal representing image data, and outputs the converted image data to the scan number converter 26 and the APL detector 28. After receiving the image data corresponding one screen from the A/D converter 25, the APL detector 28 calculates, based on the image data indicating the grayscale level of each discharge cell in the screen, a total of the grayscale levels in the screen, and obtains a value by dividing the total value by the total number of discharge cells. After that, the APL detector 28 obtains an average picture level (APL value) by calculating a percentage of the above division result value to a maximum grayscale level (e.g. 256), and outputs the APL value to the timing generator 24. The higher the APL value is, the whiter the screen is, and the lower the APL value is, the darker the screen is.

Having received the image data from the A/D converter 25, the scan number converter 26 converts the image data into pieces of image data that corresponds to the number of pixels of the panel unit 10, and outputs the converted image data pieces to the subfield converter 27. The subfield converter 27 is provided with a subfield memory (unillustrated) and converts the image data pieces transferred from the scan number converter 26 into pieces of subfield data and temporarily stores the subfield data in the subfield memory. Each piece of the subfield data is a set of binary data indicating ON/OFF of the discharge cell in each subfield that is used for displaying gradation of the image data on the panel unit 10. The subfield converter 27 then outputs the subfield data to the data driver 21 in accordance with a timing signal received from the timing generator 24.

The data driver 21 converts the image data for each subfield into signals corresponding to each of the data electrodes Dat (1) to Dat (m), and individually drives the data electrodes Dat. The data driver 21 is provided with a publicly known driver IC and the like.

The timing generator 24 generates a timing signal based on the inputted horizontal sync signal H and the vertical sync signal V, and outputs the generated signal to the drivers 21, 22, and 23. The timing generator 24 judges, based on the APL value inputted by the APL detector 28, whether each reset period of subfields constituting one field is an entire-cell or a selective-cell reset period, and controls the number of times of application to the entire-cell reset period in one field.

The scan driver 22 applies a driving voltage to the scan electrodes Scn (1) to Scn (n) in accordance with the timing signal received from the timing generator 24. The scan driver 22 is provided with a publicly known driver IC, as with the data driver 21.

The sustain driver 23 is provided with a publicly known driver IC, and applies a driving voltage to the sustain electrodes Sus (1) to Sus (n) in accordance with the timing signal received from the timing generator 24.

### 3. Method of Driving PDP Apparatus 1

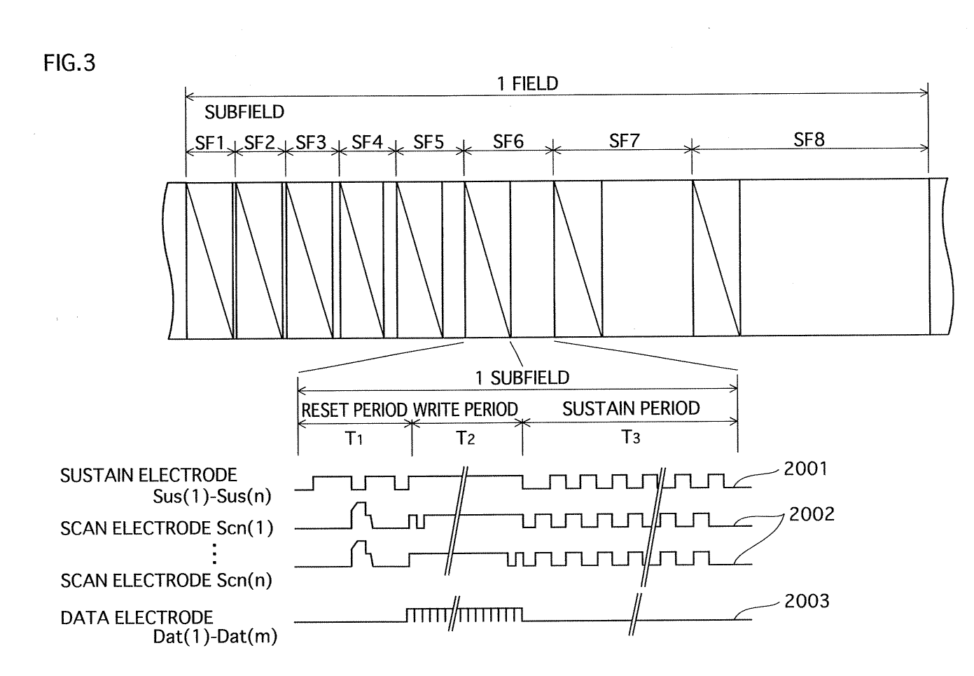

A driving method of the PDP apparatus 1 with the above structure is described with reference to FIG. 3. FIG. 3 is a waveform chart showing the driving method of the PDP apparatus 1 using the in-field time division gray scale display method (subfield method).

As shown in FIG. 3, according to an exemplary driving of the PDP apparatus 1, one field is divided into 8 subfields SF1 to SF8 so as to express 256 grayscale levels. Each of the subfields SF1 to SF8 is constituted from three periods: a reset period T₁, a write period T₂, and a sustain period T₃. A voltage pulse 2001 is applied to the sustain electrodes Sus (1) to Sus (n). A voltage pulse 2002 is applied to the scan electrodes Scn (1) to Scn (n). And a voltage pulse 2003 is applied to the data electrodes Dat (1) to Dat (m).

To drive the PDP apparatus 1, first in the reset period T₁, a reset discharge is generated in all the discharge cells of the panel unit 10, thereby eliminating the effect of the discharge having or not having been generated in the individual discharge cells in the preceding subfield and absorbing any variance in the discharge properties. In the reset period T₁, as shown in FIG. 3, the reset discharge is generated by applying a ramp waveform voltage pulse whose slope (voltage-time) has a gently rising portion and a gently falling portion to the scan electrodes Scn (1) to Scn (n), with a weak discharge current being constantly applied. Thus, the reset discharge, which is weak, is generated once during each rising and falling portion of the ramp waveform voltage pulse in all of the discharge cells of the panel unit 10.

In the write period T₂ subsequent to the above reset period T₁, the Scan electrodes Scn (1) to Scn (n) are sequentially scanned line by line in accordance with the subfield data, and a write discharge (weak discharge) is generated between the scan electrodes Scn and the data electrodes Dat in each discharge cell that is intended to have a sustain discharge in the subsequent sustain period of the subfield. In the discharge cell in which the write discharge has been generated between the scan electrodes Scn and the data electrodes Dat, wall charges are accumulated on a surface of the protective layer 114 on the front panel 11, the surface facing the discharge space 13.

Subsequently, in the sustain period T₃, a rectangular waveform sustain pulse of a specified cycle (e.g. 6 μsec.) and of a specified voltage (e.g. 180 V) is applied to the sustain electrodes Sus (1) to Sus (n) and the scan electrodes Scn (1) to Scn (n). The waveform of the sustain pulse applied to the sustain electrodes Sus (1) to Sus (n) and the waveform of the sustain pulse applied to the scan electrodes Scn (1) to Scn (n) have the same cycle, and are out of phase by a half cycle. The sustain pulses are applied simultaneously to all the discharge cells in the panel unit 10.

By applying the pulses as shown in FIG. 3, a pulse discharge is generated in the written discharge cells of the panel unit 10 every time when an alternating voltage is applied so that the polarities reverse in the sustain period T₃. Due to such a sustain discharge, a resonance line having a wavelength of 147 [nm] is emitted from excited Xe atoms, and a molecular line of 173 [nm] is emitted from excited Xe molecules in the discharge space 13. As a consequence, ultraviolet rays are generated and converted into visible light by the phosphor layer 124 of the back panel 12, and thus images are displayed on a screen.

### 4. Superior Properties of PDP Apparatus 1

In the PDP apparatus 1 pertaining to the present embodiment, the binary gas mixture (Xe—Ne) fills the discharge space 13 of the panel unit 10 and the ratio of the Ne gas in the discharge gas (the partial pressure ratio of the Ne gas to the total pressure) is set to 5[%]. That is to say, the ratio of the Xe gas in the discharge gas is as high as 95[%]. This ensures the PDP apparatus 1 of the present embodiment to have high luminous efficiency (discharge efficiency), as described above. In addition, 5[%] of the Ne gas contained in the discharge gas in the PDP apparatus 1 effectively keeps the low firing voltage, unlike the discharge gas composed of 100[%] Xe gas disclosed in Patent Documents 1 or the discharge gas having the ultrahigh total pressure in Patent Document 2.

In the PDP apparatus 1 pertaining to the present embodiment, since the Ne gas in the discharge gas is set to 5[%], erosion of the protective layer 114 as a result of sputtering induced by the discharge during driving is unlikely to occur, which leads to the effect of realizing the PDP apparatus with a long life. The reason for this is described later.

In the panel unit 10 pertaining to the present embodiment, MgO is used as a constituent material of the protective layer 114 of the front panel 11. Although MgF₂ (magnesium fluoride) may be used as the constituent material, MgO is the optimum material for the protective layer considering its secondary electron emission coefficient and its sputtering resistance. Thus, the panel unit 10 having the protective layer 114 made of MgO is advantageous for its high luminous efficiency and its sputtering resistance during driving.

In addition, in the panel unit 10, since each of the scan electrodes Scn and the sustain electrodes Sus constituting the display electrode pairs 112 is made of only a metal material such as Ag, the panel unit 10 obtains an advantage in terms of manufacturing cost, compared with a conventional panel unit that has a layered-structure of a transparent electrode made of ITO and a bus electrode made of a metal material. It should be noted that the reason why the electrodes Scn and Sus can be made solely of a metal material is because the PDP apparatus 1 of the present embodiment has excellent luminous efficiency so that each width of the electrodes Scn and Sus can be narrowed down. Since the electrodes Scn and Sus are made of a metal material, a sputtering method may be used to form the electrodes so that thin and low-resistant electrodes can be achieved.

Note that different variations can be adopted for the PDP apparatus 1 of the present embodiment. In the panel unit 10, the Xe gas is adopted as the principal gas component in the discharge gas. However, a krypton (Kr) gas, for example, may be adopted instead. The total pressure of the discharge gas is set to 5×10⁴ [Pa] in the structure of the panel unit 10. However, the total pressure in a range of 1×10⁴ [Pa]-5×10⁴ [Pa], inclusive, may be favorably adopted in view of suppressing a firing voltage on driving the PDP apparatus 1. When the fill pressure is set below 1×10⁴ [Pa], the luminous efficiency of the panel unit 10 becomes lower than that of a conventional panel unit.

Conversely, when the fill pressure is higher than 5×10⁴ [Pa], a firing voltage rises as with the panel unit of Patent Document 2. In a panel unit having a basically identical structure with the panel unit 10, when the fill pressure is increased to 6×10⁴ [Pa], for example, a firing voltage rises to approximately 700 [V].

Furthermore, although the Ne gas content in the discharge gas is set to 5[%] in this embodiment, any value of the content is acceptable as long as the value is 8[%] or below. Note that a gas composition with no Ne gas content should be avoided for the above reasons.

### 5. Content of Ne Gas in Discharge Gas

### Partial Pressure Ratio to Total Pressure

Based on the structure of the panel unit 10, samples were prepared with different Xe gas and Ne gas contents to investigate changes in a firing voltage and a sputtering rate of the protective layer 114 caused by a discharge during driving of the panel.

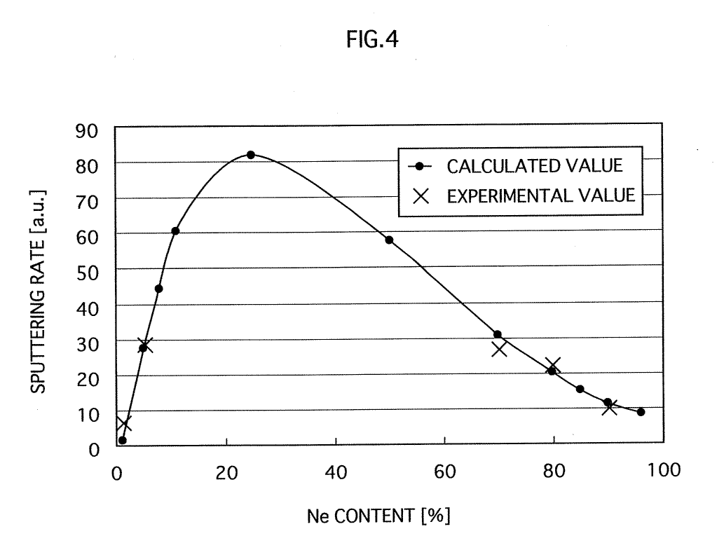

FIG. 4 shows a relationship between the sputtering rate of the protective layer 114 and the content (partial pressure ratio) of the Ne gas in the discharge gas. Calculated values and experimental values are shown in FIG. 4. Note that the calculation of the sputtering rate was conducted in consideration of a sputtering probability of each ion, ion density, and ion energy dispersion.

As shown in FIG. 4, calculation and experiment were conducted on the samples at the partial pressure ratio of the Ne gas in a range of 0[%] to 95[%]. The results show that the calculated values and experimental values are consistent with each other. The maximum sputtering rate is observed at the partial pressure ratio of the Ne gas of approximately 25[%], and the sputtering rate rises rapidly according to an increase in the partial pressure ratio of the Ne gas. However, when the partial pressure ratio of the Ne gas is in a range of 25[%] to 95[%], the higher the partial pressure ratio of the Ne gas is, the lower the sputtering rate becomes.

When the sputtering rate rises, the protective layer gets eroded so that the panel unit cannot be used for a long period. In other words, the high sputtering rate shortens a life of the PDP apparatus and thus lowers its reliability. For that reason, there is an upper limit to the acceptable sputtering rate.

The results shown in FIG. 4 indicate that the partial pressure of the Ne gas needs to be set to 5[%] or below, or 70[%] and over. Unfortunately, however, the discharge efficiency declines when the content of the Xe gas in the discharge gas is low. Thus, the partial pressure of the Ne gas of 5[%] or below is suitable for achieving a highly-efficient and extended-life PDP apparatus.

Note that too high a partial pressure ratio of the Xe gas, as with Patent Document 1, causes an increase in a firing voltage. Therefore, the Ne gas needs to be added to the discharge gas so as to suppress the firing voltage even a little.

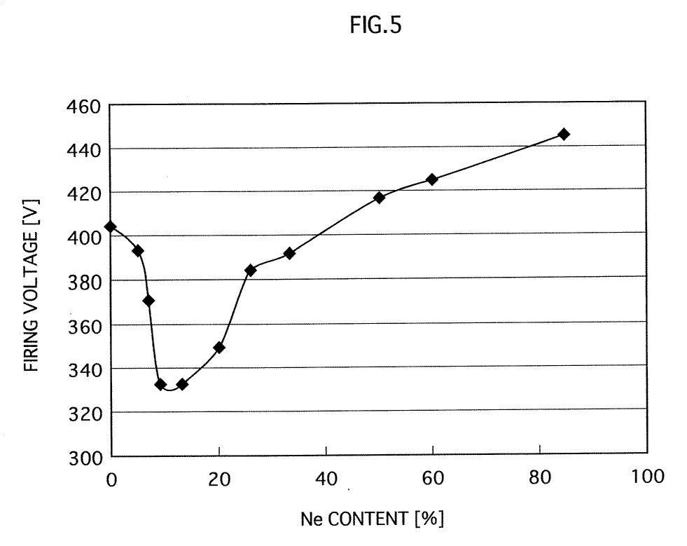

Subsequently, a relationship between the partial pressure ratio of the Ne gas and the firing voltage is described with reference to FIG. 5. FIG. 5 is a characteristic chart showing the firing voltage depending on the partial pressure ratio of the Ne gas. Note that in FIG. 5, the partial pressure ratio of the Xe gas is maintained at 2×10⁴ [Pa], while the partial pressure ratio of the Ne gas is changed by adding the Ne gas to the discharge gas.

Generally speaking, a pressure increase results in a firing voltage increase. However, this does not hold in a case that the Ne gas is added to the Xe gas. As shown in FIG. 5, when the partial pressure ratio of the Ne gas is 10[%] or below, the firing voltage decreases. When the partial pressure ratio of the Ne gas exceeds 10[%], the firing voltage is likely to rise as the partial pressure ratio of the Ne gas increases.

As shown in FIG. 5, when the partial pressure ratio of the Ne gas is in a range of 10[%] to 30[%], in spite of an increase in the total pressure, a lower firing voltage is observed compared with when no Ne gas is added. In addition, the firing voltage can be reduced even when the partial pressure ratio of the Ne gas is 0.2[%], which shows a minute amount of the Ne gas addition is still effective. This is because Ne ions brings about an increase in the secondary electron emission coefficient of the protective layer 114 made of MgO.

Accordingly, the discharge gas is desirably the Xe/Ne gas mixture, and the partial pressure ratio of the Ne gas is 5[%] or below. Thus, high luminous efficiency (discharge efficiency) is achieved, erosion of the protective layer 114 because of sputtering is suppressed, and the firing voltage is decreased.

Although data of a neon-gas-free discharge gas (partial pressure ratio of Ne gas=0%) is not plotted in FIG. 5, the firing voltage rises when no Ne gas is contained in the discharge gas, as disclosed in Patent Document 1.

Note that although the Xe gas is adopted as the principal gas component of the discharge gas in this embodiment, a krypton gas may be adopted instead. No change would be observed in the experimental results in FIGS. 4 and 5 if the krypton gas were used as the principal gas component.

### Second Embodiment

Subsequently, a PDP apparatus pertaining to a second embodiment of the present invention is described as follows.

A structure of a panel unit of the second embodiment is basically identical with that of the first embodiment shown in FIGS. 1 and 2. Structural differences are simply as follows: a fill pressure (total pressure) in the discharge gas is 3.5×10⁴ [Pa]; a dielectric layer in the front panel unit is made of oxide silicon; a thickness of the dielectric layer is approximately 20 [μm]; and Al—Nd is used for the respective electrodes Scn and Sus that compose the display electrode pairs.

In addition, the partial pressure of the Ne gas in the discharge gas is set to 8[%] in this embodiment. A description of other structural parts of the panel unit and the PDP apparatus of this embodiment is omitted, as these parts are basically identical with those described in the first embodiment.

In the panel unit of the PDP apparatus pertaining to the present embodiment, the dielectric layer of the front panel is made of oxide silicon of which a dielectric constant is lower than that made of low-melting glass in the first embodiment. Therefore, if a capacity that can store electric charges in the discharge space is set as high as that of the panel unit 10, the dielectric layer can be from one half to one third as thick as the original layer of the first embodiment. For that reason, in the panel unit pertaining to the present embodiment, it is possible to thin down the thickness of the dielectric layer to 20 [μm] which is thinner by 5 [μm] than the dielectric layer 113 with the thickness of 25 [μm] of the panel unit 10. The reduction of the thickness contributes to a decrease in a discharge voltage.

In addition to the advantages possessed by the PDP apparatus 1 of the first embodiment, the PDP apparatus and the panel unit having the above structure are able to reduce damages to the protective layer because of sputtering as a result of a discharge during driving. More specifically, the reduction of the thickness of the dielectric layer serves to lower the discharge voltage, which leads to reduce energy of ions colliding to the protective layer even if the partial pressure ratio of the Ne gas in the discharge gas is 8[%].

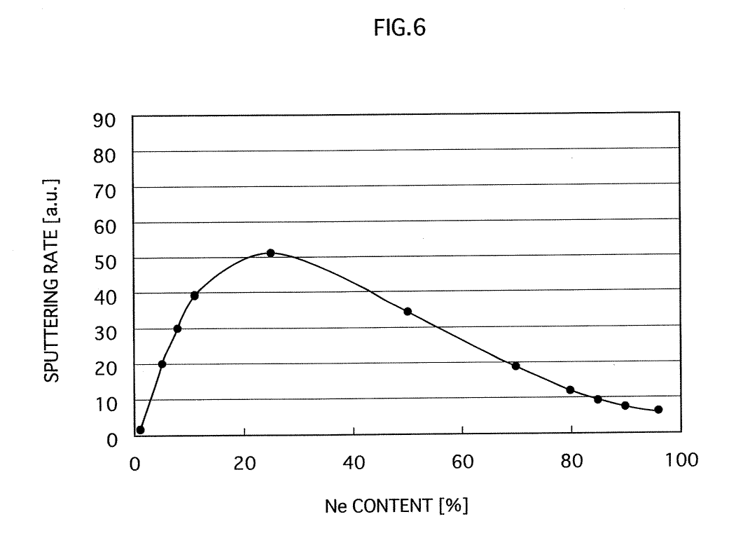

Following describes a confirmatory experiment conducted to verify the above advantages of the PDP apparatus pertaining to the present embodiment with reference to FIG. 6. FIG. 6 corresponds to FIG. 4, and shows a relationship between the content (partial pressure ratio) of the Ne gas in the discharge gas and the sputtering rate of the protective layer. Note that since the discharge gas is made of the Xe/Ne binary gas mixture, the rest of the gas mixture except for the Ne gas is naturally the Xe gas in this experiment.

As shown in FIG. 6, the maximum sputtering rate is observed at the partial pressure ratio of the Ne gas of approximately 25[%]. Although this result is similar to that in FIG. 4, the maximum sputtering rate in FIG. 6 is lower than that in FIG. 4 by 30 points. This owes to the dielectric layer that is made of oxide silicon to be as this as 20 [μm].

Also, as shown in FIG. 6, the sputtering rate rises rapidly according to an increase in the partial pressure ratio of the Ne gas in a range of 0[%] to 25[%], as in FIG. 4. When the partial pressure ratio of the Ne gas is in a range of 25[%] to 95[%], the sputtering rate declines as the ratio of the Ne gas increases.

These results show that by specifying the partial pressure ratio of the Ne gas in the discharge gas to be 8[%] or below in the panel unit of the present embodiment, the PDP apparatus can achieve both high luminous efficiency and a long life. Note that, also in this embodiment, there is a precondition that the discharge gas contains Ne gas (e.g. 0.2%) even if an amount thereof may be small.

FIG. 6 additionally shows that the partial pressure ratio of the Ne gas of 5[%] or below further lowers the sputtering rate, and thus effectively achieves high luminous efficiency (discharge efficiency), suppresses erosion of the protective layer 114 caused by sputtering, and decreases the firing voltage.

Note that, in the PDP apparatus pertaining to the present embodiment as well, the total pressure of the discharge gas may be set in the range of 1×10⁴ [Pa]-5×10⁴ [Pa], inclusive, and respective electrodes Scn and Sus composing the display electrode pairs may be made of Ag. The reasons for these are similar to those disclosed in the first embodiment. Each of the electrodes Scn and Sus is preferred to be thin so as to prevent breakdown of the dielectric layer because of the thinness of the dielectric layer.

Instead of the Xe gas, a krypton gas may be used as the principal gas component of the discharge gas, which also shows the similar superiority to that in the first embodiment.

### Third Embodiment

Following is a description of a PDP apparatus and a panel unit pertaining to a third embodiment of the present invention.

The PDP apparatus and the panel unit of the present embodiment have a basically identical structure with that in the second embodiment. A difference between the second and the present embodiments is the composition of the discharge gas. That is, an Xe—Ne—Ar ternary gas mixture is used as the discharge gas in the panel unit of the present embodiment. The respective partial pressure ratios of the Ne gas and the Ar gas in the discharge gas are set to 5[%]. The total pressure of the discharge gas is set to 3.5×10⁴ [Pa], as in the second embodiment. Other structural parts than these are basically identical with those in the second embodiment.

The panel unit of the present embodiment contains an Ar gas in the discharge gas for the following reason. Ar ions are less likely to cause sputtering than Ne ions, therefore Ar gas addition does not influence a life of the panel unit. Moreover, the Ar gas addition to the discharge gas is expected to cause Xe excitation. Therefore, the PDP apparatus of the present embodiment further improves the luminous efficiency compared with the PDP apparatus of the second embodiment.

In addition, the Ar ions cause a larger secondary electron emission coefficient of the protective layer than Xe ions do, therefore a decrease in a firing voltage of the PDP apparatus of the present embodiment can be expected.

Accordingly, the PDP apparatus of the present embodiment is even more advantageous than the PDP apparatus of the first and second embodiments in achieving high luminous efficiency (discharge efficiency), in suppressing erosion of the protective layer caused by sputtering, and in decreasing a firing voltage.

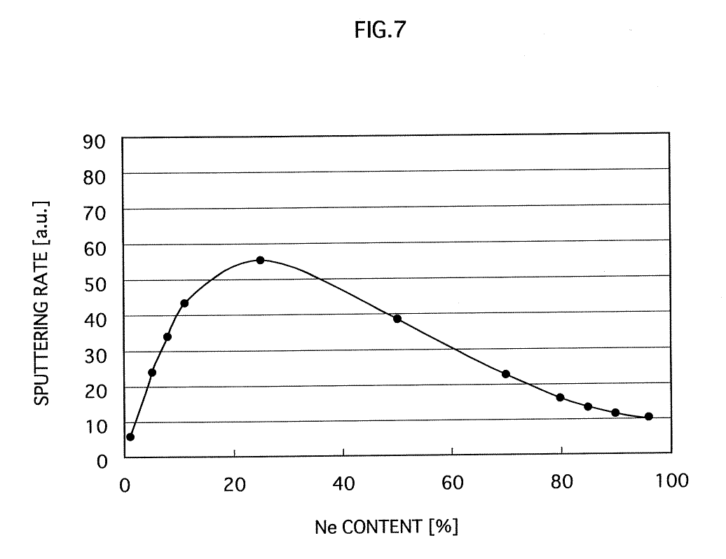

FIG. 7 shows confirmatory test results of a relationship between the sputtering rate and the partial pressure ratio of the Ne gas of the PDP apparatus pertaining to the present embodiment.

As shown in FIG. 7, when the Xe—Ne—Ar ternary gas mixture is used as the discharge gas, the maximum sputtering rate is observed at the partial pressure ratio of the Ne gas of approximately 25[%]. This shows the sputtering rate of the protective layer is in accordance with the partial pressure ratio of the Ne gas in the discharge gas. More specifically, FIG. 4 and FIG. 7 being compared, both FIG. 4 and FIG. 7 show that the maximum sputtering rate is observed at the partial pressure ratio of the Ne gas of approximately 25[%] regardless of the 5[%] content of the Ar gas in the discharge gas in FIG. 7. This shows that the Ne gas content in the discharge gas is what determines erosion of the protective layer due to sputtering.

Note that different variations can be adopted for the PDP apparatus and the panel unit pertaining to the present embodiment, as with the first and second embodiments.

### [Investigation on Thickness of Dielectric Layer and Sputtering Rate]

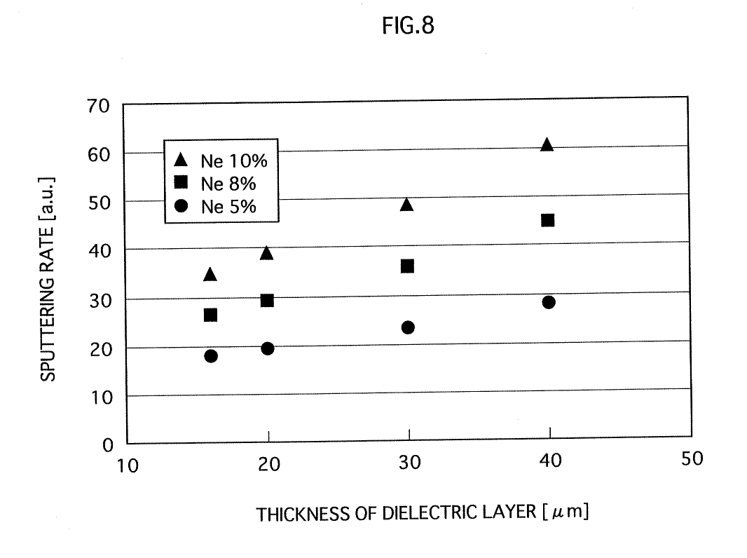

Subsequently, a relationship between the sputtering rate and the thickness of the dielectric layer is described as follows with reference to FIG. 8. FIG. 8 is a characteristic chart showing the sputtering rate of the protective layer depending on the thickness of the dielectric layer.

As shown in FIG. 8, when the partial pressure ratio of the Ne gas to the total pressure ratio of the discharge gas is 10[%], and when the thickness of the dielectric layer is in a range of the 15 [μm]-40 [μm], all sputtering rates indicate “30” and over. On the other hand, when the partial pressure ratio of the Ne gas to the total pressure ratio of the discharge gas is 5[%], and when the thickness of the dielectric layer is within the above range, all sputtering rates indicate below “30”.

Furthermore, as shown in FIG. 8, when the partial pressure ratio of the Ne gas to the total pressure ratio of the discharge gas is 8[%], and when the thickness of the dielectric layer is 20 [μm] or below, the sputtering rate indicates below “30,” which is desirable for the PDP apparatus with a long life.

These results show that, for the panel unit and the PDP apparatus, the thickness of the dielectric layer is preferred to be 20 [μm] or below, providing that the partial pressure ratio of the Ne gas is 8[%] or below. However, when the partial pressure ratio of the Ne gas is 5[%], as evident from FIG. 8, the dielectric layer with the thickness of 40 [μm] or below enables the PDP apparatus and the panel unit to achieve both a long life and high luminous efficiency. For example, for manufacturing a conventional dielectric layer that is formed through a process of coating with a paste that contains low-melting glass and burning, the partial pressure ratio of the Ne gas of 5[%] or below results in the sputtering rate of the protective layer to be less than “30,” which is desirable from a perspective of both extending a life and improving luminous efficiency of the PDP apparatus and the panel unit.

### [Investigation on Neon Gas Content in Discharge Gas and Aging Time in Manufacturing Process]

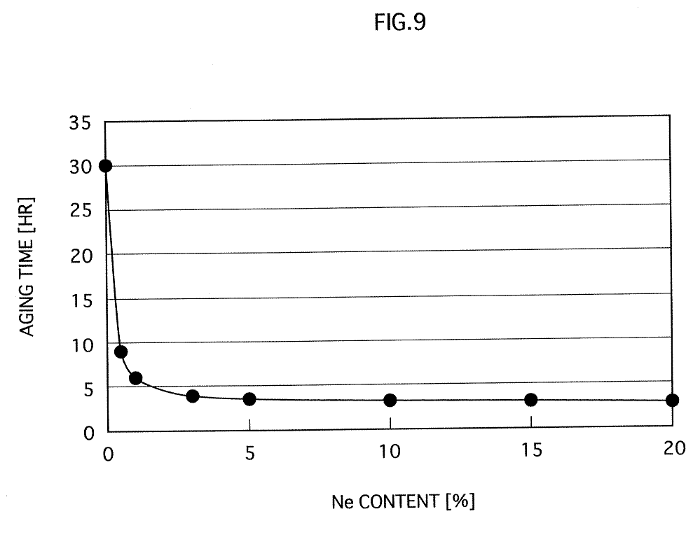

The following describes a relationship between a content of the Ne gas and an aging time in a manufacturing process with reference to FIG. 9. PDP apparatus samples having basically an identical structure with that shown in FIGS. 1 and 2 were used to conduct this investigation. Note that the Xe—Ne binary gas mixture is used as the discharge gas, the partial pressure of the Xe gas is maintained at 20 [kPa] (150 Torr), and the Ne gas is added to the Xe gas to make the partial pressure ratio of the Ne gas fall within a range of the 0[%]-20[%]. Note that the aging time is a time required for an initial variance of the firing voltage to stabilize, for example, in a range of 250 [V]±5 [V].

As shown in FIG. 9, when the partial pressure ratio of the Ne gas in the discharge gas is smaller than 3[%], the aging time rapidly shortens as the ratio of the Ne gas increases. When the ratio of the Ne gas is 3[%] and over, little change in the aging time is observed. In summary, the partial pressure ratio of the Ne gas in the discharge gas is preferred to be 3[%] and over in order to reduce the aging time.

### [Investigation on Discharge Gap and Occurrence of Spots]

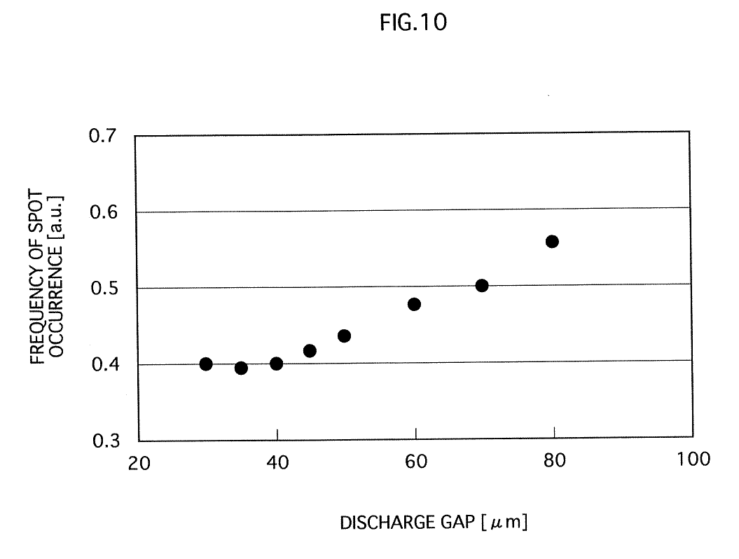

Following is a description of a characteristic chart showing a relationship between occurrence of spots and a distance (discharge gap) between the scan electrodes Scn and the sustain electrode Sus of the front panel 11 with reference to FIG. 10. Note that PDP apparatus samples having a structure shown in FIGS. 1 and 2 are used in this investigation, provided that the Xe—Ne binary gas mixture is used as the discharge gas, that the partial pressure ratio of the Xe gas is 95[%], that the partial pressure ratio of the Ne gas is 5[%], and that the total pressure of the discharge gas is 24 [kPa]. The apparatus samples were so prepared to differ from one another in width of the discharge gap between the electrodes Scn and Sus constituting the display electrode pairs 112 in a range of 30 [μm]-80 [μm]. The occurrence of spots was observed with the samples.

As shown in FIG. 10, when the discharge gap is smaller than 40 [μm], the frequency of spot occurrence is constantly around “0.4.” When the discharge gap is 40 [μm] and over, the frequency is apt to increase according to the width of the discharge gap. As occurrence of spots is a crucial factor that determines a display quality, it is demanded that the spots are not to occur even when a total driving time of the PDP apparatus is long (e.g. 60,000 hours, which is the PDP apparatus life). For example, the frequency of spot occurrence in FIG. 10 is desired to be “0.5” or below so as to suppress the occurrence of spots in the 60,000-hour life.

Note that the discharge gap smaller than 40 [μm] results in too large reactive power during driving. The discharge gap larger than 70 [μm] results in occurrence of spots when a driving time is long.

Accordingly, the desirable width of the discharge gap is in a range of 40 [μm]-70 [μm], inclusive, in consideration of decreasing the reactive power and suppressing the occurrence of spots for a long driving hours.

### [Investigation on Height of Barrier Ribs 123 and Occurrence of Spots]

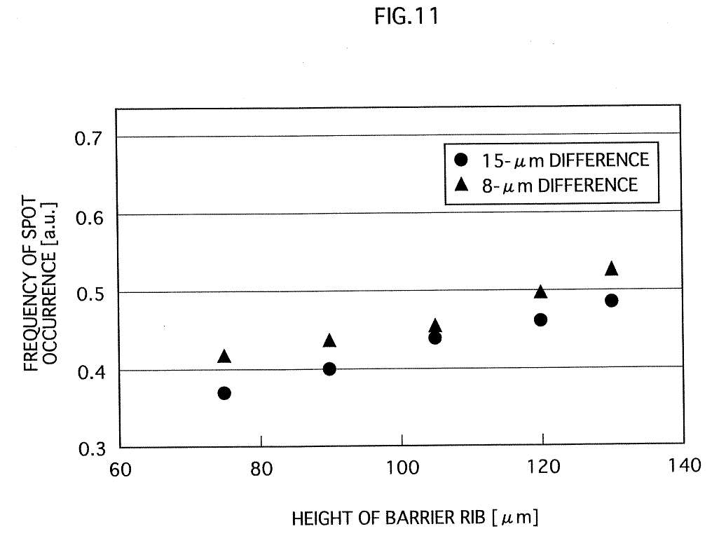

Following describes a relationship between a height of the barrier ribs 123 and occurrence of the spots with reference to FIG. 11. Note that this investigation was conducted on the premise that the height of the barrier ribs 123 was larger than the distance of the discharge gap between the electrodes Scn and Sus constituting the display electrode pairs 112, and that the main barrier ribs 1231 of the barrier ribs 123 were higher than the sub-barrier ribs 1232 of the barrier ribs 123. Other structural parts are basically identical with those in the above investigation on the discharge gap and the occurrence of spots.

In this investigation, a difference in height between the main barrier ribs 1231 and the sub-barrier ribs 1232 is set at two levels.

The difference is set at 8 [μm] or 15 [μm]. In either case, as shown in FIG. 11, the frequency of the spot occurrence rises with an increase in the height of the barrier ribs 123 (the main barrier ribs 1231). In addition, at each height of the barrier ribs observed in this investigation, the frequency of the spot occurrence is lower when the difference is 15 [μm] than 8 [μm]. Note that the lower the height of the main barrier ribs 1231 is, the higher the firing voltage tends to be. Especially when the height the main barrier ribs 1231 is lower than 75 [μm], the firing voltage tends to rise rapidly.

In addition, when the main barrier ribs 1231 are 120 [μm] or below, the frequency of spot occurrence indicates 0.5 or below, which is able to suppress the occurrence of spots when the total driving time is long. Thus, the height of the main barrier ribs 1231 ranging from 75 [μm] to 120 [μm], inclusive, is desirable from a perspective of suppressing both the firing voltage and occurrence of spots when the total driving time is long.

### [Additional Particulars]

The above embodiments only provide examples to describe the configuration of the PDP and the PDP apparatus pertaining to the present invention and the effects obtained therewith. Accordingly, the present invention is not restricted to these except for the characterizing aspects. For example, the first and second embodiments use the Xe—Ne binary gas mixture as the discharge gas, and the third embodiment uses the Xe—Ne—Ar ternary gas mixture. However, a discharge gas that contains the Ne gas in the above range to principal gas component can be adopted. Also, a gas mixture containing any of a Kr—Ne, Kr—Ne—Ar, Xe—Ne—He, Xe—Ne—He—Ar, and Kr—Ne—He—Ar is applicable for the discharge gas.

In addition, although phosphor materials constituting each of the phosphor layers 124R, 124G, and 124B are provided as examples in the first embodiment and the like, other than those, each of the following phosphor materials can also be used.

R phosphor; (Y, Gd) BO₃: Eu

G phosphor; a mixture of (Y, Gd) BO₃: Tb and Zn₂SiO₄: Mn

B phosphor; BaMg₂Al₁₄O₂₄: Eu

Furthermore, in the above embodiments, a gas component such as an Xe gas and a Kr gas that emits ultraviolet rays with a wavelength of 147 [nm] or 173 [nm] responding to a discharge is adopted as the principal gas component. However, the component may be changed according to the constituent materials of the phosphor layer 124 of the back panel 12.

Additionally, in the first, second and third embodiments, the PDP apparatus has the structure shown in FIG. 2 and the panel unit has the structure shown in FIG. 1. However, the structure of the PDP apparatus and the panel unit is not restricted to those of the present embodiments.

Furthermore, the thickness of the dielectric layer is 25 [μm] in the first embodiment and 20 [μm] in the second and third embodiments. However, the thickness may be changed to any other value. Note that the value needs to be set in consideration of the relationship between the firing voltage on driving the PDP apparatus and the breakdown of the dielectric layer.

Furthermore, the scan electrodes Scn and the sustain electrodes Sus that constitute the display electrode pairs are made of Ag in the first embodiment, and Al—Nd in the second and third embodiments. However, the present invention is not limited to those embodiments. For example, an electrode with a layered structure of a transparent electrode made of ITO and a bus line made of a metal material can be used, as been adopted by the conventional PDP apparatus, and a layered product of Cu—Cr—Cu can be adopted as well. In addition, since the structure of the present invention enables the PDP apparatus and the panel unit to have high luminous efficiency mentioned as above, the display electrode pairs can be made of a different metal material than Ag, or Al—Nd, and the transparent electrode made of ITO and the like is unnecessary.

### INDUSTRIAL APPLICABILITY

The present invention can maintain a stable display quality for a long time of driving without sacrificing high luminous efficiency. Thus, it is possible to apply the present invention to a large high-definition television, a large display apparatus and the like.

1. A plasma display panel having a first substrate and a second substrate that oppose each other with a space therebetween, a plurality of electrode pairs, a dielectric layer, and a protective layer being stacked in the stated order on a main surface of the first substrate, the protective layer facing the space, a phosphor layer that faces the protective layer being disposed over a main surface of the second substrate, the space being filled with a discharge gas, wherein
the discharge gas contains:
a principal gas component composed of a component that emits light to excite a phosphor in the phosphor layer during a plasma discharge; and
a neon gas, and wherein
the principal gas component is contained at a principal ratio of the discharge gas, and
the neon gas is contained at a partial pressure ratio of 8% or less to a total pressure of the discharge gas.

2. The plasma display panel of claim 1, wherein
the dielectric layer has a thickness of less than 20 μm.

3. The plasma display panel of claim 1, wherein
the neon gas is contained at a partial pressure ratio of 5% or less to the total pressure of the discharge gas.

4. The plasma display panel of claim 1, wherein
the neon gas is contained at a partial pressure ratio of at least 0.2% to the total pressure of the discharge gas.

5. The plasma display panel of claim 1, wherein
the neon gas is contained at a partial pressure ratio of at least 3% to the total pressure of the discharge gas.

6. The plasma display panel of claim 1, wherein
an argon gas is contained in the discharge gas.

7. The plasma display panel of claim 1, wherein
the total pressure of the discharge gas is from 1×10⁴ Pa to 5×10⁴ Pa, inclusive.

8. The plasma display panel of claim 1, wherein
the total pressure of the discharge gas is from 1.7×10⁴ Pa to 5×10⁴ Pa, inclusive.

9. The plasma display panel of claim 1, wherein
each electrode that constitutes the electrode pairs is made of a metal material.

10. The plasma display panel of claim 1, wherein
the protective layer is made of magnesium oxide.

11. The plasma display panel of claim 1, wherein
the principal gas component is one of a xenon gas and a krypton gas.

12. The plasma display panel of claim 1, wherein
each of the electrode pairs on the main surface of the first substrate includes two electrodes that are spaced from each other at a distance from 40 μm to 70 μm, inclusive.

13. The plasma display panel of claim 12 having:
electrodes each disposed on the main surface of the second substrate so as to intersect the electrode pairs three-dimensionally;
a dielectric layer disposed on the main surface of the second substrate so as to cover the electrodes;
barrier ribs each disposed on a surface of the dielectric layer on the second substrate between the electrodes that are adjacent to each other, the barrier ribs each standing toward the first substrate, and wherein
a height from a top of each barrier rib to the surface of the dielectric layer on the second substrate is larger than the distance between the two electrodes.

14. The plasma display panel of claim 13, wherein
the height from the top of each barrier rib to the surface of the dielectric layer on the second substrate is from 75 μm to 120 μm, inclusive.

15. The plasma display panel of claim 14, wherein
sub-barrier ribs are each disposed on the surface of the dielectric layer on the second substrate so as to intersect the barrier ribs, the sub-barrier ribs each being formed in an area which corresponds to an area between the electrode pairs on the first substrate and standing toward the protective layer on the first substrate,
the height from the top of each barrier rib to the surface of the dielectric layer on the second substrate is larger than a height from a top of each sub-barrier rib to the surface of the dielectric layer on the second substrate, and
a difference in the height of each barrier rib and the height of each sub-barrier rib is from 8 μm to 15 μm, inclusive.

16. A plasma display panel apparatus including:
a panel unit having a first substrate and a second substrate that oppose each other with a space therebetween, a plurality of electrode pairs, a dielectric layer, and a protective layer being stacked in the stated order on a main surface of the first substrate, the protective layer facing the space, a phosphor layer that faces the protective layer being disposed over a main surface of the second substrate, the space being filled with a discharge gas; and
a drive unit operable to apply, in accordance with an inputted image signal, a voltage pulse to each electrode constituting the electrode pairs of the panel unit, and wherein
the discharge gas contains:
a principal gas component composed of a component that emits light to excite a phosphor in the phosphor layer during a plasma discharge; and
a neon gas, and wherein
the principal gas component is contained at a principal ratio of the discharge gas, and
the neon gas is contained at a partial pressure ratio of 8% or less to a total pressure of the discharge gas.

17. The plasma display panel apparatus of claim 16, wherein
the dielectric layer has a thickness of less than 20 μm.

18. The plasma display panel apparatus of claim 16, wherein
the neon gas is contained at a partial pressure ratio of 5% or less to the total pressure of the discharge gas.

19. The plasma display panel apparatus of claim 16, wherein
the neon gas is contained at a partial pressure ratio of at least 0.2% to the total pressure of the discharge gas.

20. The plasma display panel apparatus of claim 16, wherein
the neon gas is contained at a partial pressure ratio of at least 3% to the total pressure of the discharge gas.

21. The plasma display panel apparatus of claim 16, wherein
an argon gas is contained in the discharge gas.

22. The plasma display panel apparatus of claim 16, wherein
the total pressure of the discharge gas is from 1×10⁴ Pa to 5×10⁴ Pa, inclusive.

23. The plasma display panel apparatus of claim 16, wherein
the principal gas component is one of a xenon gas and a krypton gas.
